(19) United States
(12) Patent Application Publication
(10) Pub. No.: US 2026/0220041 A1
(43) Pub. Date: Jul. 30, 2026

(54) KEY VALUE PAIR CACHE MANAGEMENT

(71) Applicant: NVIDIA Corporation, Santa Clara, CA (US)

(72) Inventors: Payman Behnam, Norcross, GA (US); Yaosheng Fu, Santa Clara, CA (US); Ritchie Zhao, Redmond, WA (US); Po-An Tsai, Somerville, MA (US); Zhiding Yu, Cupertino, CA (US)

(21) Appl. No.: 19/041,619

(22) Filed: Jan. 30, 2025

(51) Int. Cl. G06F 12/0802

(52) U.S. Cl. CPC G06F 12/0802

(57) ABSTRACT

Key-value (KV) management processes can be a training-free approach to KV cache compression, addressing the challenges of memory bandwidth and capacity demands during the decode phase of source material using large language model (LLM) inference. The KV management processes can contain two consecutive stages: a KV cache eviction algorithm for coarse-grain KV cache eviction and a hybrid attention process for fine-grain dynamic KV token selection. The hybrid attention process can have three steps, (1) grouping KV pages along the sequence dimension while storing the minimum and maximum values, (2) accumulating the query data in a group dimension finding the largest index along the head dimension, and then performing an approximation attention, and (3) a sparse attention can be performed by fetching the KV pair vectors from the top K indices. KV management processes can maintain comparable accuracy to KV cache attention while lowering memory bandwidth and capacity usage.

### TECHNICAL FIELD

This application is directed, in general, to improving the operation of large language models and, more specifically, to managing memory cache.

### BACKGROUND

When implementing large language models (LLM), inefficiencies can be introduced through tracking and storing key value (KV) pairs. As the number of KV pairs increases, memory constraints can become apparent in the system. The processor utilizing the LLM on source material has a limited amount of processor memory to store KV pairs while the input data is being processed. Some solutions have been proposed such as KV cache offloading or KV cache compression to address memory capacity and bandwidth issues. These solutions may not properly identify critical KV pairs that can be offloaded or discarded. Improving the handling of storing KV pairs would be beneficial to LLM processing.

### SUMMARY

In one aspect, a method is disclosed. In one embodiment, the method includes (1) receiving a source material and input parameters, and (2) decoding the source material using a large language model (LLM), wherein the decoding includes (2a) ascertaining an input sequence of the source material, and (2b) identifying key-value (KV) pairs stored in at least one KV cache, wherein the at least one KV cache is managed using a KV management process comprising of a KV cache eviction algorithm and a dynamic KV token selection algorithm, wherein the KV cache eviction algorithm uses an adaptive pooling size and the dynamic KV token selection algorithm applies a hybrid attention process.

In a second aspect, a system is disclosed. In one embodiment, the system includes (1) a memory unit, capable of storing one or more key-value (KV) pairs in at least one KV cache, (2) a processing unit capable of executing code to decode a source material using a large language model (LLM) and the one or more KV pairs, wherein the processing unit is communicatively coupled to the memory unit, and (3) a KV management unit capable of managing the one or more KV pairs stored in the at least one KV cache, wherein the KV management unit utilizes a KV cache eviction algorithm and a dynamic KV token selection algorithm, wherein the dynamic KV token selection algorithm uses a hybrid attention process and the KV cache eviction algorithm uses an adaptive pooling size.

In a third aspect, a non-transitory computer program product having a series of operating instructions stored on a non-transitory computer-readable medium that directs a key-value (KV) management process when executed thereby to perform operations. In one embodiment, the operations include (1) receiving a source material and input parameters, and (2) decoding the source material using a large language model (LLM), wherein the decoding includes (2a) ascertaining an input sequence of the source material, and (2b) identifying key-value (KV) pairs stored in at least one KV cache, wherein the at least one KV cache is managed using a KV management process comprising of a KV cache eviction algorithm and a dynamic KV token selection algorithm, wherein the KV cache eviction algorithm uses an adaptive pooling size and the dynamic KV token selection algorithm applies a hybrid attention process.

In a fourth aspect, a processing unit is disclosed. In one embodiment, the processing unit includes (1) a code execution system, capable of decoding a source material using a large language model (LLM), wherein the LLM utilizes a multi-turn interaction framework, (2) a key-value (KV) cache capable of storing one or more KV pairs computed by the LLM for the source material, and (3) a KV management unit, capable of managing the one or more KV pairs stored in the KV cache, wherein the KV management unit utilizes a KV cache eviction algorithm and a dynamic KV token selection algorithm, wherein the dynamic KV token selection algorithm uses a hybrid attention process and the KV cache eviction algorithm uses an adaptive pooling size.

In a fifth aspect, a processing unit system is disclosed. In one embodiment, the processing unit system includes (1) a code execution system, capable of decoding a source material using a large language model (LLM), (2) a key-value (KV) cache system capable of storing one or more KV pairs used by the LLM, and (3) a KV management system, capable of managing the one or more KV pairs stored in the KV cache utilizing a KV cache eviction algorithm and a dynamic KV token selection algorithm, wherein the dynamic KV token selection algorithm uses a hybrid attention process and the KV cache eviction algorithm uses an adaptive pooling size.

### BRIEF DESCRIPTION

Reference is now made to the following descriptions taken in conjunction with the accompanying drawings, in which:

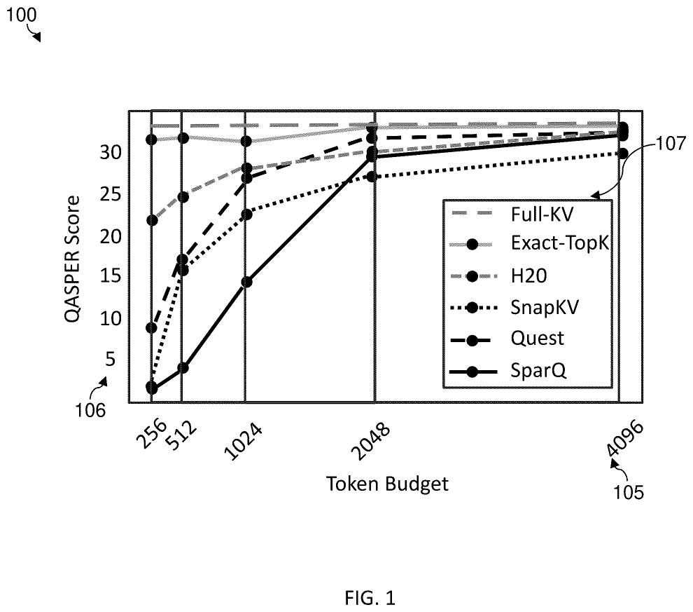

FIG. 1 is an illustration of a diagram of an example graph showing the relative performance of various KV cache handling algorithms;

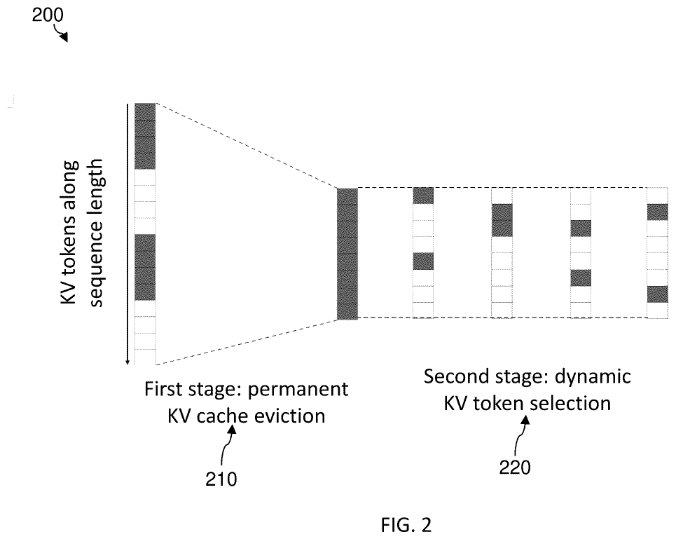

FIG. 2 is an illustration of a diagram of an example two-stage KV management process;

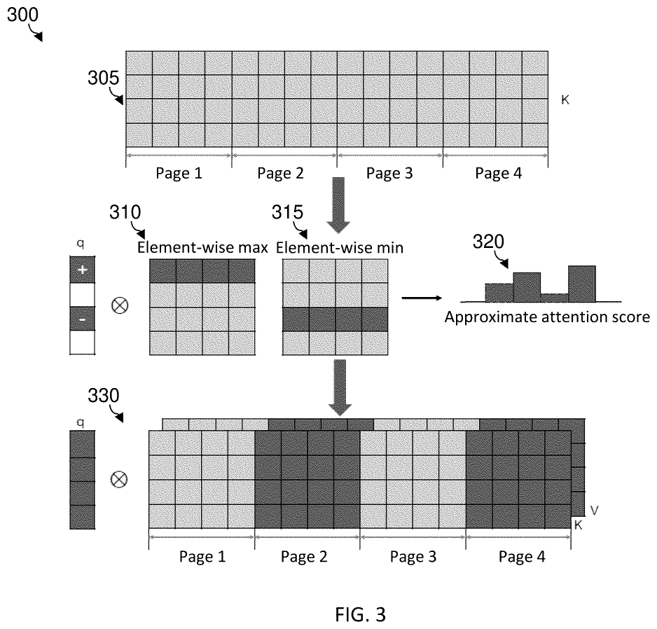

FIG. 3 is an illustration of a diagram of an example hybrid attention process demonstrating the KV management processes;

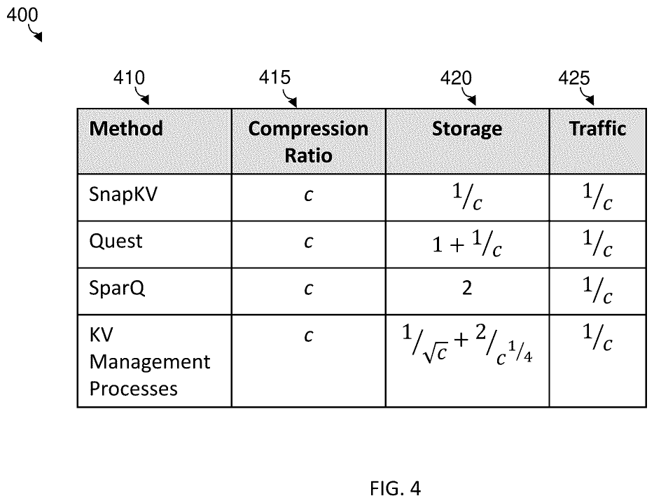

FIG. 4 is an illustration of a table of an example comparison between existing cache processes and the disclosed KV management processes;

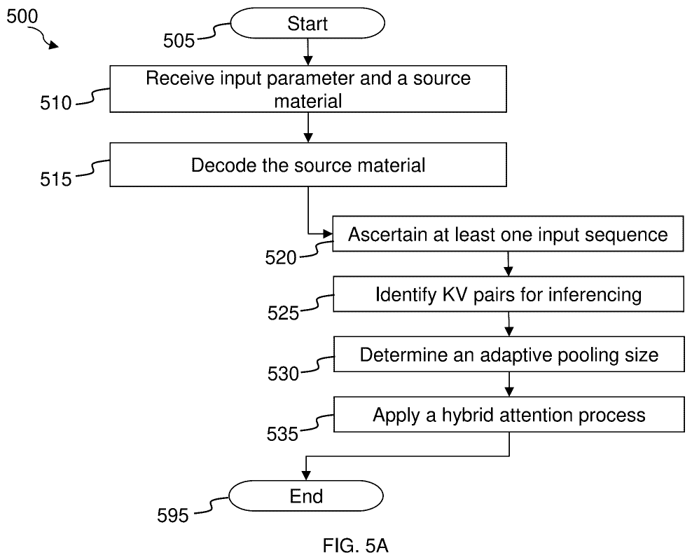

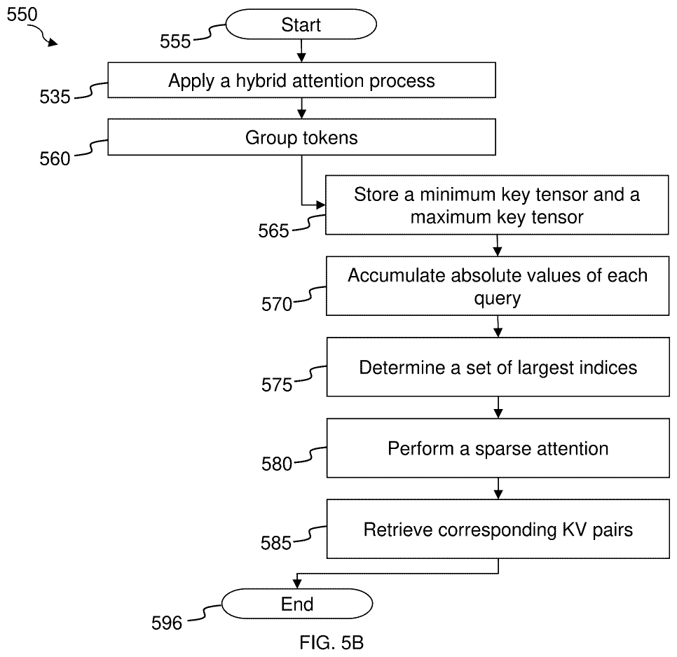

FIG. 5A is an illustration of a flow diagram of an example method to use a KV management process to manage KV pairs during the processing of source material using an LLM with a multi-turn interaction framework;

FIG. 5B is an illustration of a flow diagram of an example method 550 applying a hybrid attention process;

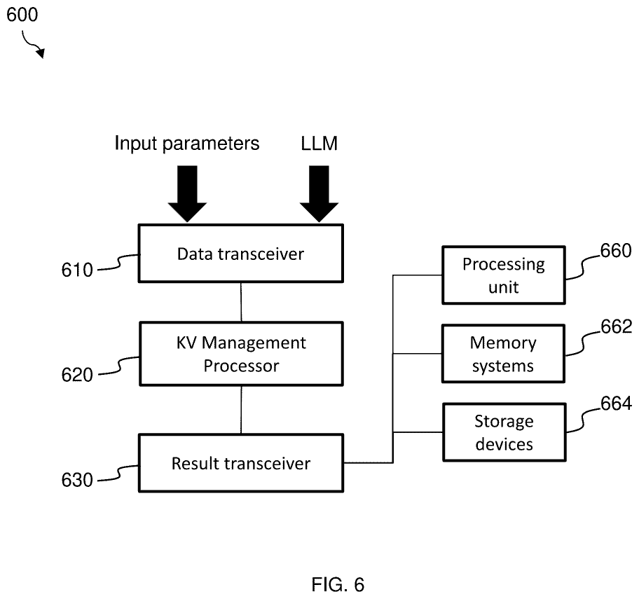

FIG. 6 is an illustration of a block diagram of an example KV management system; and

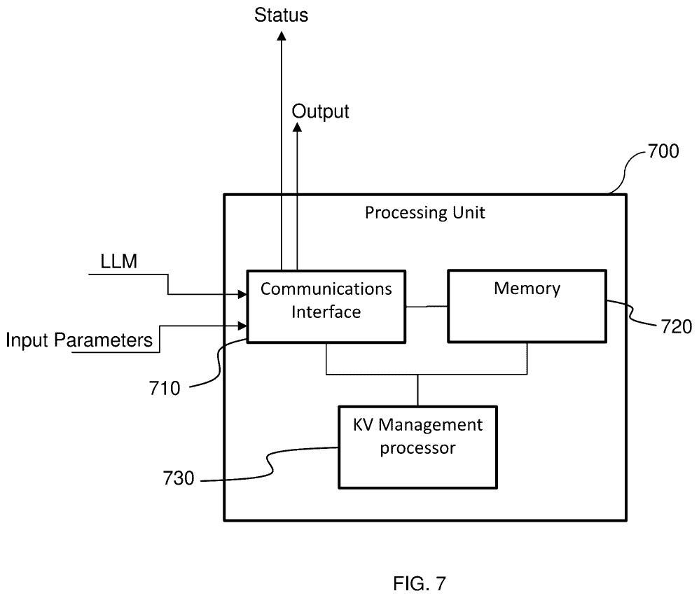

FIG. 7 is an illustration of a block diagram of an example of a KV management controller according to the principles of the disclosure.

### DETAILED DESCRIPTION

The landscape of artificial intelligence (AI) is quickly evolving. These advanced applications can harness multiple models in complex structures, such as multi-turn interactions and branching pathways. Within this framework, multi-turn interactions can be essential, enabling large language models (LLMs) to tackle sophisticated tasks with increased precision and relevance. However, executing multi-turn interactions in LLM inference models may not be efficiently processed. Due to the limited capacity of processor memory, the key-value (KV) pairs of previous turns can be discarded after one or more turns complete their processing. As interactions progress, the discarding action can lead to a large re-computation of previous KV pairs. The re-computation process of the KV pairs can be time-consuming, resulting in longer prefill latencies and a decline in Time to First Token (TTFT) performance. Therefore, developing an efficient KV cache management can be necessary to retain and reuse KV pairs. This can be for single-turn interactions where the input sequence length is long or in multi-turn interactions to reduce prefill overheads.

In transformer-based LLM inference, the key-value cache (KV cache), which stores past attention keys and values to avoid re-computation, becomes a major bottleneck at the decode phase, as its size scales linearly with the sequence length and batch size. For example, Llama3.1-70B-Instruct model with a batch size of 32 and a context length of 32K may need around 320 GB of KV cache storage at FP16 precision, which even advanced hardware can have difficulty handling.

The processor used to execute the code for the LLM processing model can be of various types, such as a central processing unit (CPU), a graphics processing unit (GPU), a single instruction multiple data (SIMD) processor, or other types of processors. The processors can have at least some internal memory locations, e.g., processor memory, DRAM memory, or cache, available to store KV pairs. The cache can be an L1 cache, an L2 cache, or other memory locations. Memory locations can be located proximate to the processor, such as with nearby one or more processors, logic chips, or memory chips. Memory locations can be located along a communication bus, such as in a memory module, or other memory storage devices such as a solid-state drive.

Multi-turn interactions can be used across various agentic and compound AI applications, as they can allow the models to process and build upon information over a sequence of exchanges, rather than treating each query in isolation. This capability can be essential for complex applications that benefit from retaining context and a deeper comprehension of past interactions, such as those in dialog systems, personalized recommendations, and complex question-answering scenarios. In such environments, the volume and complexity of information stored as the KV pairs can increase significantly. Maintaining the KV pairs in a memory cache can be used, as it can help ensure that the models provide contextually accurate and coherent responses. Proper KV cache management can be a key factor in enhancing the performance and scalability of LLMs in real-world applications.

A small subset of KV tokens can be typically used at each decoding step to maintain accuracy. Therefore, if those KV tokens can be accurately predicted in advance, dense attention operations can be replaced with sparse attention operations with significant memory bandwidth and capacity improvement. Those methods fall into two categories: (1) permanent KV token eviction, and (2) dynamic KV token selection. Category 1 can result in memory bandwidth and storage savings while leading to noticeable accuracy loss if KV tokens dropped earlier are subsequently used at later decode steps. Category 2 can avoid the shortcomings of Category 1 by keeping the KV tokens in the memory and dynamically selecting a subset each time. As a result, this option results in memory bandwidth savings while using extra memory storage overhead for auxiliary data.

This disclosure presents processes to implement KV management processes that can maintain a KV cache more efficiently than conventional processes when decoding a source material using an LLM. In some aspects, the KV cache can be stored on a processor unit, a processor chip, a processor circuit board, a second processor unit, or an external memory cache, such as other processor units, memory chips, solid state drives (SSDs), or other memory storage locations. In some aspects, the KV cache can be stored in processor memory, an L1 cache, an L2 cache, or other types of memory. In some aspects, the KV cache can be more than one KV cache. In some aspects, the KV cache can be stored in more than one type of memory cache, for example, partly stored in a processor memory and partly stored in an L2 cache. In some aspects, there can be more than one L1 cache. In some aspects, there can be more than one L2 cache. For example, a processor unit can have access to two L2 caches on a circuit board, and the L2 caches can be used to support the KV management processes. In some aspects, various combinations of the above aspects can be implemented as well using this disclosure.

The available PCIe bandwidth, re-computation overheads, and system performance can vary based on model size, input length, and system configurations. In some aspects, a runtime decision-making framework that determines whether to recompute the KV cache or offload it to host memory can be part of the disclosed processes.

To achieve improved handling of memory bandwidth and memory capacity (e.g., the memory cache where the KV cache is stored, whether internal or external to a processor unit, such as L1 cache, L2 cache, memory chips, or other memory locations), while improving LLM accuracy, the KV management processes can combine permanent KV cache compression with dynamic KV token selection in the decoding phase of the LLM inference of the source material.

In some aspects, the KV management process can use a KV cache eviction algorithm for coarse-grain prompt KV token compression. In some aspects, the KV cache eviction algorithm can improve existing techniques (for example, SnapKV) by using adaptive pooling size and be compatible with grouped-query attention (GQA). In some aspects, the KV cache eviction algorithm can maintain compatibility with GQA by accumulating per-group attention scores enabling the KV pairs to be shared across an attention group.

In some aspects, the KV management process can perform fine-grain dynamic KV token selection with a hybrid attention mechanism which can estimate indices with top-k attention scores by leveraging head and sequence dimensional reductions.

In some aspects, the KV management process can analyze and identify the limitations of existing KV token-dropping methods and utilize a two-stage KV compression process. A first stage can utilize a KV cache eviction algorithm that can use adaptive pooling size while maintaining compatibility with GQA to identify KV pairs that can be safely evicted from the KV cache. Eviction means the removal of the KV pair from the KV cache. In some aspects, the evicted KV pair can be copied to another memory cache location, such as a second L2 cache or an external memory location. In some aspects, the evicted KV pair can be discarded. At a second stage, a hybrid attention for dynamic KV token selection at each decode step can be used.

In evaluating the disclosed KV management processes on a wide variety of models and downstream tasks, the KV management processes demonstrate comparable accuracy with full KV attention while maintaining KV token budgets as low as 256. In further evaluations using specific processor units, on an NVIDIA H100 GPU, there was a three-time end-to-end speedup while reducing peak memory consumption by up to 31% at the decode phase.

Turning now to the figures, FIG. 1 is an illustration of a diagram of an example graph 100 showing the relative performance of various KV cache handling algorithms. Existing training-free KV cache eviction methods for decoding phase acceleration can be categorized into two types: permanent KV cache eviction and dynamic KV token selection. Graph 100 presents the accuracy comparison of four different methods for qasper benchmark in LongBench on Mistral-7B model, where H2O and SnapKV belong to the first type, and Quest and SparQ belong to the second type.

As shown in graph 100, the accuracy of the four methods drops significantly as the token budget becomes lower than 1024. In comparison, Exact-TopK performs sparse attention on top-k indices selected based on the exact attention scores. Exact-TopK achieves a negligible accuracy drop compared to the Full KV cache even with a token budget of 256, which indicates that the other methods fail to accurately predict top-k KV tokens at low token budgets.

To improve the prediction accuracy, permanent KV cache eviction and dynamic KV token selection can be complementary to each other and can be combined. Permanent KV cache eviction can be performed with a larger token budget first and then conduct dynamic KV token selection on the remaining KV tokens. By doing this, the chance of permanently evicting useful KV tokens is reduced. Meanwhile, dynamic KV token selection can be performed on a subset of KV tokens rather than the original full set, significantly lowering the prediction difficulty.

Graph 100 has an x-axis 105 showing the relative token budget in bytes. A y-axis 106 shows the accuracy qasper score where higher is better. A key 107 shows the key to each of the selected algorithms that were evaluated.

FIG. 2 is an illustration of a diagram of an example two-stage KV management process 200. Two-stage KV management process 200 performs coarse-grain KV cache eviction at a first stage 210. The purpose of this stage can be to remove KV tokens with low importance while trying to keep the majority of useful tokens. In a second stage 220, the processes can conduct fine-grain dynamic KV token selection on the remaining KV tokens followed by top-k sparse attention. For a given token budget t and associated compression ratio c, the compression ratio can be allocated across the stages so that each stage can result in a compression ratio of \sqrt{c}. In some aspects, the compression ratio can be evenly distributed. In some aspects, to further achieve improved performance at each stage, a KV cache eviction method and a dynamic KV token selection method can be applied at each stage.

In the first stage, a KV cache compression process can be applied to the inputs. Two enhancements can be made to existing compression techniques to improve the performance: 1) Ensure compatibility with GQA, and 2) utilize adaptive kernel size for pooling. Existing methods keep crucial KV tokens based on aggregated per-head attention scores across the observation window. In the case of GQA, each attention head within an attention group will keep a separate set of KV cache tokens which could introduce redundant storage of the same KV token. To be compatible with GQA, the disclosed KV cache eviction algorithm accumulates per-group rather than per-head attention scores so that the selected KV tokens are shared across the attention group.

Some existing methods use pooling to retain the completeness of selected information. Their employed kernel sizes for pooling are typically small, for example, a kernel size of seven. Since the disclosed KV cache eviction algorithm can be used for coarse-grain KV token eviction at the first stage, the optimal kernel size for pooling can be significantly larger. The optimal kernel size could grow as the input sequence length increases. Therefore, the KV cache eviction algorithm can provide a simple adaptive kernel size selection mechanism based on the input sequence length, e.g., a smaller kernel size can be selected if the input sequence length is shorter than a sequence threshold parameter. A larger kernel size can be selected if the input sequence length is equal to or longer than the sequence threshold parameter. Different adaptive kernel sizes can be used for different sequence lengths of the source material, where the same kernel size is used for similar sequence lengths of the source material.

The determined kernel sizes (e.g., one for sequence lengths shorter than the sequence threshold and one for sequence lengths equal to or larger than the sequence threshold) and the sequence threshold parameters can be determined through experimentation, can be specified by a user, or can be defaulted to pre-determined parameters. The overall algorithm of the KV cache eviction algorithm is illustrated in Algorithm 1.

```
Algorithm 1: Example KV cache eviction algorithm
  Input: sequence length S, query vector q, key tensor K,
  value tensor V, kernel
  sizes ks₁ and ks₂, kernel threshold Thr, top-k KV indices k
# compute Attention scores based on observation window
  s₁ ← AttnScore(q_{obs}, kₚᵣₑ)
# accumulate attention score on sequence and group dim
  s₂ ← sum(s₁)
# adaptively select kernel size for pooling
  ks ← ks₁ if S ≥ Thr else ks₂
# perform pooling on sequence dim
  s₃ ← pool(s₂, ks)
# get indices with top-k attention scores
  i ← argtopk(s₃, k)
# generate pruned KV cache
  K_{cache} ← K_{[i,obs]}, V_{cache} ← V_{[i,obs]}
return K_{cache}, V_{cache}
```

FIG. 3 is an illustration of a diagram of an example hybrid attention process 300 demonstrating the KV management processes. Previous methods of dynamic KV token selection often leverage the sparsity in the head or sequence dimension of the Q or K tensor to estimate top-k attention scores. Relying on the sparsity of a single dimension can limit the degree of the compression ratio, beyond which the accuracy could drop rapidly as shown in FIG. 1. This disclosure demonstrates a hybrid attention process that takes advantage of sparsity in head and sequence dimensions to achieve improved estimation accuracy on indices with top-k attention scores. Hybrid attention process 300 shows one aspect of the. Hybrid attention process 300 can be decomposed into an algorithm with three steps.

Step 1: Tokens in K can be grouped (e.g., grouping tokens) into consecutive pages 305 along the sequence dimension and store element-wise a maximum 310 and a minimum 315 for each page as auxiliary storage. Maximum 310 and minimum 315 can be stored along the head dimension to enable improved efficiency when performing step 2. The auxiliary storage can be updated each time a new key token is generated and stored.

Step 2: For each query q, the process can accumulate |q| in group dimension first and find the r largest indices along the head dimension. Then the process can fetch the corresponding entries in element-wise the minimum or maximum storage depending on the sign of the sum of q in group dimension at those indices. Subsequently, the process can perform an approximation attention 320 based on those partial q and K values and find top-k indices in the sequence dimension.

Step 3: A sparse attention 330 can be performed by fetching the full key and value vectors from the top-k indices. Steps 2 and 3 can be implemented using an algorithm, for example, Algorithm 2.

```
Algorithm 2: Example Hybrid Attention Algorithm
  Input: query vector q, key tensor K, value tensor V,
  element-wise max/min key
  tensor Kₘₐₓ/Kₘᵢₙ, top-r q indices r, top-k KV indices k
# get top-r indices in sum of |q| in group dim
  i₁ ← argtopk(sum(|q|), r)
# get signs of top-r indices in sum of q in group dim
  g ← sign(sum(q)_{[i}^{₁}]_{]})
# fetch entries from paged min or max based on signs
  P ← Kₘₐₓ [i : gᵢ ≥ 0], Kₘᵢₙ [i : gᵢ < 0]
# compute approximation attention scores
  s1 ← AttnScore(q_{[i}^{₁}_{]}, P)
# get indices with top-k attention scores
  i2 ← argtopk(s₁, k)
# perform sparse attention
  y ← Attn(q, Kᵢ^{₂}, Vᵢ^{₂})
return y
```

The K tensor can be compressed along the sequence dimension first for auxiliary storage and then selectively fetched along the head dimension for approximation attention calculation. For a given compression ratio c, the compression can be split between those two steps so that each step results in a compression ratio of \sqrt{c}. This can avoid accuracy loss caused by over-compression on a single dimension. The disclosed processes can be compatible with GQA because the selections on the key and value vectors are based on a per-attention group rather than an attention head.

FIG. 4 is an illustration of a table of an example comparison 400 between existing cache processes and the disclosed KV management processes. The decoding phase of the source material (e.g., LLM inference phase) can be memory-bound so the time spent in the attention module can be proportional to the total memory traffic. Comparison 400 uses a token budget t to estimate the amount of memory traffic for each attention operation in the decode phase, focusing on KV cache traffic since it contributes to most memory traffic in this scenario. For example, a token budget of 512 means each attention module fetches an equivalent amount of 512 KV pairs from the memory. For models with GQA, this token budget can be defined for the attention group rather than each attention head. For a given sequence length S, the total compression ratio c can be defined as c=S/t.

In some aspects, the total compression ratio can be evenly split between the stages with each stage having a compression ratio of \sqrt{c}, therefore in the first stage, this results in memory storage and traffic reduction of \sqrt{c}. In the second stage, the additional memory storage overhead introduced by approximation attention can be taken into consideration. Since the compression ratio \sqrt{c} is evenly split in our hybrid attention algorithm between steps 1 and 2, the memory storage overhead can be

$$1 / \sqrt{c} \times {c}_{1 / 4} \times 2 = 2 / {c}_{1 / 4} .$$

Therefore, in this aspect, the total KV cache storage can be

$$1 / \sqrt{c} + 2 / {c}_{1 / 4}$$

and the traffic can be 1/c of the KV baseline. Comparison 400 compares the KV cache storage and traffic of the disclosed KV management processes against other methods 410 at a given compression ratio c 415. While each method leads to KV cache traffic savings 425, the KV management processes provide additional KV cache storage savings 420 over the other methods. Quest and SparQ may need extra storage for auxiliary data.

In terms of system-level optimizations, the KV management processes can be compatible with FlashAttention as it does not modify attention in the prefill phase, as well as Tensor Parallelism as the operations can be symmetric across attention heads/groups.

FIG. 5A is an illustration of a flow diagram of an example method 500 to use a KV management process to manage KV pairs during the processing of source material using an LLM with a multi-turn interaction framework. Method 500 can be performed on a computing system, for example, KV management system 600 of FIG. 6 or KV management controller 700 of FIG. 7. The computing system can be one or more processors in various combinations (e.g., CPUs, GPUs, SIMDs, or other types of processors), a data center, a cloud environment, a server, a laptop, a mobile device, a smartphone, a PDA, or other computing system capable of compiling code for a targeted processing unit. Method 500 can be encapsulated in software code or hardware, for example, an application, code library, code module, dynamic link library, module, function, RAM, ROM module, and other software and hardware implementations. The software can be stored in a file, database, or other computing system storage mechanism. Method 500 can be partially implemented in software and partially in hardware. Method 500 can perform the steps for the described processes, for example, managing the access and retrieval of KV pairs in one or more KV caches.

Method 500 starts at a step 505 and proceeds to a step 510. In step 510, input parameters can be received. The input parameters can be one or more of an LLM to utilize if more than one LLM is available, a sequence threshold parameter, an adaptive pooling size parameter to use with the sequence threshold parameter, or other input parameters used to direct operation of the KV management process. Source material can be received. The source material can be one of various types of written material, video material, audio material, or other material that is recorded and able to be communicated to other systems.

In step 515, the source material can be decoded in an inference phase using the LLM. The Decoding stage utilizes one or more KV pairs that are stored in a KV cache. The management of the KV cache can be used as the number of KV pairs increases as the KV cache has limited memory available to it for storing the KV pairs, where the memory can be one or more of L1 cache, L2, other processor cache, memory chips, memory stacks, SSDs, or other memory locations. The KV management process implements a two-stage algorithm for managing the KV cache, a KV cache eviction algorithm and a dynamic KV token selection algorithm.

In a step 520, at least one input sequence is ascertained from the source material. In a step 525, the KV pairs to be used for inferencing of the input sequence can be identified and lead to permanent KV cache eviction. The input sequence can be processed using the LLM and the KV pairs to decode and inference the input sequence and produce an output appropriate for the LLM being used.

In a step 530, the KV cache eviction algorithm can utilize a variable kernel pooling size, depending on the length of the input sequence. In some aspects, the adaptive pooling size can be a proportion of the length of the input sequence. In some aspects, the adaptive pooling size can use a sequence threshold parameter, wherein a first kernel size is used for the adaptive pooling size when the length of the input sequence is less than the sequence threshold parameter, and a second kernel size is used for the adaptive pooling size when the length is equal to or greater than the sequence threshold parameter.

In a step 535, the dynamic KV token selection algorithm can apply a hybrid attention process, where minimum key tensors and maximum key tensors are stored for the KV pairs to enhance the efficiency in retrieving KV pairs. Method 500 ends at a step 595.

FIG. 5B is an illustration of a flow diagram of an example method 550 applying a hybrid attention process. Method 550 can be performed on a computing system, for example, KV management system 600 of FIG. 6 or KV management controller 700 of FIG. 7. The computing system can be one or more processors in various combinations (e.g., CPUs, GPUs, SIMDs, or other types of processors), a data center, a cloud environment, a server, a laptop, a mobile device, a smartphone, a PDA, or other computing system capable of compiling code for a targeted processing unit. Method 550 can be encapsulated in software code or hardware, for example, an application, code library, code module, dynamic link library, module, function, RAM, ROM module, and other software and hardware implementations. The software can be stored in a file, database, or other computing system storage mechanism. Method 550 can be partially implemented in software and partially in hardware. Method 550 can perform the steps for the described processes, for example, managing the access and retrieval of KV pairs in one or more KV caches.

Method 550 extends method 500 with optional steps implementing the hybrid attention process. Method 550 starts at a step 555 and proceeds to step 535 from method 500. Proceeding from step 535, method 550 proceeds to a step 560 where tokens of the source material can be grouped into key tensors of consecutive pages along a sequence dimension. In some aspects, in a step 565, a minimum key tensor and a maximum key tensor for each page can be stored. In some aspects, the minimum key tensor and the maximum key tensor can be stored along a head dimension. In some aspects, the minimum key tensor and the maximum key tensor can be updated when a new KV pair is generated.

In a step 570, the absolute values of each query in the group dimension can be accumulated. In a step 575, a set of largest indices along a head dimension can be determined. The largest indices are along the head dimension while the pages are along the sequence dimension, which means the process can select a subset of elements on the minimum-maximum vectors per page.

In an optional step 580, sparse attention can be performed by fetching a KV vector using the set of largest indices. In a step 585, the corresponding KV pairs can be retrieved using the minimum key tensor when the sum of each query is less than zero or the maximum key tensor when the sum of each query is equal to or greater than zero, where the sum of each query is along the group dimension. Method 550 ends at a step 596.

FIG. 6 is an illustration of a block diagram of an example KV management system 600. KV management system 600 can be implemented in one or more computing systems or one or more processors. In some aspects, KV management system 600 can be a processing unit system. In some aspects, KV management system 600 can be implemented using a KV management controller such as KV management controller 700 of FIG. 7. KV management system 600 can implement one or more aspects of this disclosure, such as method 500 of FIG. 5A or method 550 of FIG. 5B.

KV management system 600, or a portion thereof, can be implemented as an application, a code library, a dynamic link library, a function, a module, a header file, other software implementation, or combinations thereof. In some aspects, KV management system 600 can be implemented in hardware, such as a ROM, a graphics processing unit, or other hardware implementation. In some aspects, KV management system 600 can be implemented partially as a software application and partially as a hardware implementation. KV management system 600 is a functional view of the disclosed processes, and an implementation can combine or separate the described functions in one or more software or hardware systems.

KV management system 600 includes a data transceiver 610, a KV management processor 620, and a result transceiver 630. The output, e.g., the management of at least one KV cache storing at least two KV pairs, can directed to memory where the KV cache is stored, such as a memory cache of one or more processing units 660 (one or more combinations of processor units or processing cores), one or more memory systems 662 (e.g., L1 cache or L2 cache of chips, or memory stacks), or one or more storage devices 664 (e.g., an SSD).

In some aspects, the KV management system 600, such as those communicated to one or more processing units 660, one or more storage devices 664, or one or more memory systems 662, can be used to retrieve KV pairs as used by the decoding of a sequence of the multi-turn interaction framework during decoding of the source material by using the LLM.

Data transceiver 610 can receive the input parameters, including the number and type of KV caches on the processor, the number and type of caches on other processors or chips (e.g., one or more processing units 660), or the number and type of KV caches in the memory systems (one or more memory systems 662). The input parameters can be a sequence threshold parameter. The input parameters can include default kernel sizes for various sequence lengths. In some aspects, data transceiver 610 can be part of KV management processor 620.

Result transceiver 630 can communicate one or more outputs (e.g., KV pairs or directions on how to manage the KV cache), to one or more data receivers, such as one or more processing units 660, one or more memory systems 662, one or more storage devices 664, or other related systems, whether located proximate result transceiver 630 or distant from result transceiver 630. Data transceiver 610, KV management processor 620, and result transceiver 630 can be or can include, conventional interfaces configured for transmitting and receiving data. Data transceiver 610, KV management processor 620, or result transceiver 630 can be implemented as software components, for example, a virtual processor environment, a code library, function, or application code, or as hardware, for example, circuits of an integrated circuit, a communication bus, a communication channel, or combinations of software and hardware components and functionality. The functionality described for these components remains intact regardless of how the functionality is implemented.

KV management processor 620 (e.g., one or more processing units such as processor 730 of FIG. 7) can implement the analysis and algorithms as described herein utilizing the input parameters. In some aspects, KV management processor 620 can include a code execution system, capable of decoding a source material using an LLM. In some aspects, KV management processor 620 can include a KV cache system capable of storing one or more KV pairs used by the LLM. In some aspects, KV management processor 620 can include a KV management system.

KV management processor 620 can be one or more code functions or routines executing on a processor, a dedicated hardware component, a multicore processor, a multiprocessor system, or a streaming multiprocessor. KV management processor 620 can be implemented by a CPU, a GPU, or other types of processors.

A memory or data storage system of KV management processor 620 (such as a core cache, L1 cache, L2 cache, or other memory systems) can be configured to store the processes and algorithms for directing the operation of KV management processor 620. KV management processor 620 can include a processor that is configured to operate according to the analysis operations and algorithms disclosed herein, and an interface to communicate (transmit and receive) data.

FIG. 7 is an illustration of a block diagram of an example of a KV management controller 700 according to the principles of the disclosure. KV management controller 700 can be stored on one computer or multiple computers. The various components of KV management controller 700 can communicate via wireless or wired conventional connections. A portion or a whole of KV management controller 700 can be located at one or more locations. In some aspects, KV management controller 700 can be part of another system (e.g., processor, core, server, or other systems), and can be integrated with one device, such as a part of a processing system. KV management controller 700 represents a demonstration of the functionality employed for the disclosure, and implementations can use a variety of devices, for example, circuits or components of a processor unit, dedicated processors, virtual systems, servers, other computing or processing systems, be in software or hardware, or various combinations thereof.

KV management controller 700 can be configured to perform the various functions disclosed herein including receiving input parameters and generating results from the execution of the methods and processes described herein, such as managing one or more KV caches in support of decoding a sequence of data from source material. KV management controller 700 includes a communications interface 710, a memory 720, and a processor 730.

Communications interface 710 is configured to transmit and receive data. For example, communications interface 710 can receive the input parameters. Communications interface 710 can transmit the directions for managing the KV cache or interim outputs. In some aspects, communications interface 710 can transmit a status, such as a success or failure indicator of KV management controller 700 regarding receiving the various inputs, transmitting the generated outputs, or producing the results. Communications interface 710 can communicate via communication systems used in the industry. For example, wireless or wired protocols can be used. Communication interface 710 can perform the operations as described for data transceiver 610 and result transceiver 630 of FIG. 6.

Memory 720 can be configured to store a series of operating instructions that direct the operation of processor 730 when initiated, including supporting code representing the algorithm for implementing the KV management process. Memory 720 is a non-transitory computer-readable medium. Memory 720 can be a memory unit. Multiple types of memory can be used for the data storage systems and memory 720 can be distributed. Memory 720 can be configured to support one or more KV caches in support of applying the LLM to the source material.

In some aspects, processor 730 can perform the operations as described by KV management processor 620. Processor 730 can be one or more processors. Processor 730 can be a combination of processor types, such as a CPU, a GPU, a single instruction multiple data (SIMD) processor, or other processor types. Processor 730 can be a virtual process supported by a processing unit. Processor 730 can be dedicated circuitry within a processor. Processor 730 can be a code process running on a processor. Processor 730 can be configured to produce the output, one or more interim outputs, and statuses utilizing the received inputs. Processor 730 can determine the output using parallel processing. In some aspects, processor 730 can include or enable a KV management unit capable of managing one or more KV pairs stored in the at least one KV cache, wherein the KV management unit utilizes a KV cache eviction algorithm and a dynamic KV token selection algorithm, wherein the dynamic KV token selection algorithm uses a hybrid attention process and the KV cache eviction algorithm uses an adaptive pooling size.

Processor 730 can be an integrated circuit. In some aspects, processor 730, communications interface 710, memory 720, or various combinations thereof, can be an integrated circuit. Processor 730 can be configured to direct the operation of KV management controller 700. Processor 730 includes the logic to communicate with communications interface 710 and memory 720, and performs the functions described herein.

In some aspects, processor 730 can be a non-transitory computer program product having a series of operating instructions stored on a non-transitory computer-readable medium that directs a KV management process when executed thereby to perform operations as disclosed herein. In some aspects, processor 730 can perform or direct the operations as described by KV management processor 620 of FIG. 6. In some aspects, KV management system 600 or KV management controller 700 can be part of a machine learning system.

A portion of the above-described apparatus, systems, or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more other processor types, or a combination thereof. The digital data processors and computers can be located proximate to each other, proximate to a user, in a cloud environment, a data center, or located in a combination thereof. For example, some components can be located proximately to the user, and some components can be in a cloud environment or data center.

The GPUs can be embodied on one semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on one chip. Configured or configured to means, for example, designed, constructed, or programmed, with the necessary logic and/or features for performing a task or tasks.

Portions of disclosed examples or embodiments may relate to computer storage products with a non-transitory computer-readable medium that has program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include machine code, such as produced by a compiler, and files containing higher-level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

What is claimed is:

1. A method, comprising:
receiving a source material and input parameters; and
decoding the source material using a large language model (LLM), wherein the decoding includes:
ascertaining an input sequence of the source material; and
identifying key-value (KV) pairs stored in at least one KV cache, wherein the at least one KV cache is managed using a KV management process comprising of a KV cache eviction algorithm and a dynamic KV token selection algorithm, wherein the KV cache eviction algorithm uses an adaptive pooling size and the dynamic KV token selection algorithm applies a hybrid attention process.

2. The method as recited in claim 1, further comprising:
determining the adaptive pooling size as a proportion of a length of the input sequence.

3. The method as recited in claim 1, further comprising:
determining the adaptive pooling size using a sequence threshold parameter, wherein a first kernel size is used for the adaptive pooling size when a length of the input sequence is less than the sequence threshold parameter, and a second kernel size is used for the adaptive pooling size when the length is equal to or greater than the sequence threshold parameter.

4. The method as recited in claim 1, wherein the KV cache eviction algorithm further comprises:
maintaining compatibility with grouped-query attention (GQA) by accumulating per-group attention scores enabling the KV pairs to be shared across an attention group.

5. The method as recited in claim 1, wherein the hybrid attention process further comprises:
grouping tokens of the source material in a key tensor into consecutive pages along a sequence dimension; and
storing a minimum key tensor and a maximum key tensor for each page.

6. The method as recited in claim 5, wherein the minimum key tensor and the maximum key tensor are stored along a head dimension.

7. The method as recited in claim 5, wherein the minimum key tensor and the maximum key tensor are updated when a new KV pair is generated.

8. The method as recited in claim 5, wherein the hybrid attention process further comprises:
accumulating absolute values of each query in a group dimension;
determining a set of largest indices along a head dimension; and
retrieving corresponding KV pairs using the minimum key tensor when a sum of each query is less than zero or the maximum key tensor when the sum of each query is equal to or greater than zero.

9. The method as recited in claim 8, wherein the hybrid attention process further comprises:
performing a sparse attention by fetching a KV vector using the set of largest indices.

10. The method as recited in claim 5, wherein the key tensor is compressed along the sequence dimension and fetched along a head dimension.

11. The method as recited in claim 10, wherein a compression ratio is distributed to the key tensor in the sequence dimension and the key tensor in the head dimension.

12. The method as recited in claim 10, wherein a compression ratio is evenly distributed to the key tensor in the sequence dimension and the key tensor in the head dimension.

13. The method as recited in claim 1, wherein the dynamic KV token selection algorithm further comprises:
evicting KV pairs from the KV cache using a first token budget; and
performing the hybrid attention process using a second token budget, wherein the first token budget is larger than the second token budget.

14. The method as recited in claim 1, wherein the KV cache eviction algorithm further comprises:
evicting KV pairs from the KV cache using a first token budget; and
performing the hybrid attention process using a second token budget, wherein the first token budget is larger than the second token budget.

15. A system, comprising:
a memory unit, capable of storing one or more key-value (KV) pairs in at least one KV cache;
a processing unit capable of executing code to decode a source material using a large language model (LLM) and the one or more KV pairs, wherein the processing unit is communicatively coupled to the memory unit; and
a KV management unit capable of managing the one or more KV pairs stored in the at least one KV cache, wherein the KV management unit utilizes a KV cache eviction algorithm and a dynamic KV token selection algorithm, wherein the dynamic KV token selection algorithm uses a hybrid attention process and the KV cache eviction algorithm uses an adaptive pooling size.

16. The system as recited in claim 15, wherein the processing unit is a graphics processing unit (GPU).

17. The system as recited in claim 15, wherein the processing unit includes the memory unit.

18. The system as recited in claim 15, wherein the processing unit includes the KV management unit.

19. The system as recited in claim 15, wherein the processing unit includes at least one of the at least one KV cache.

20. The system as recited in claim 15, wherein the at least one KV cache is an L2 cache.

21. A non-transitory computer program product having a series of operating instructions stored on a non-transitory computer-readable medium that directs a key-value (KV) management process when executed thereby to perform operations, the operations comprising:
receiving a source material and input parameters; and
decoding the source material using a large language model (LLM), wherein the decoding includes:
ascertaining an input sequence of the source material; and
identifying key-value (KV) pairs stored in at least one KV cache, wherein the at least one KV cache is managed using a KV management process comprising of a KV cache eviction algorithm and a dynamic KV token selection algorithm, wherein the KV cache eviction algorithm uses an adaptive pooling size and the dynamic KV token selection algorithm applies a hybrid attention process.

22. The non-transitory computer program product as recited in claim 21, wherein the decoding further comprises:
determining the adaptive pooling size using a sequence threshold parameter;
grouping tokens in a key tensor into consecutive pages along a sequence dimension;
storing a minimum key tensor and a maximum key tensor for each page;
accumulating absolute values of each query in a group dimension;
determining a set of largest indices along a head dimension;
performing a sparse attention by fetching a KV vector using the set of largest indices; and
retrieving corresponding KV pairs using the minimum key tensor when a sum of each query is less than zero or the maximum key tensor when the sum of each query is equal to or greater than zero.

23. A processing unit, comprising:
a code execution system, capable of decoding a source material using a large language model (LLM), wherein the LLM utilizes a multi-turn interaction framework;
a key-value (KV) cache capable of storing one or more KV pairs computed by the LLM for the source material; and
a KV management unit, capable of managing the one or more KV pairs stored in the KV cache, wherein the KV management unit utilizes a KV cache eviction algorithm and a dynamic KV token selection algorithm, wherein the dynamic KV token selection algorithm uses a hybrid attention process and the KV cache eviction algorithm uses an adaptive pooling size.

24. The processing unit as recited in claim 23, wherein the KV management unit is further capable of determining the adaptive pooling size using a length of an input sequence of the source material and a sequence threshold parameter.

25. A processing unit system, comprising:
a code execution system, capable of decoding a source material using a large language model (LLM);
a key-value (KV) cache system capable of storing one or more KV pairs used by the LLM; and
a KV management system, capable of managing the one or more KV pairs stored in the KV cache utilizing a KV cache eviction algorithm and a dynamic KV token selection algorithm, wherein the dynamic KV token selection algorithm uses a hybrid attention process and the KV cache eviction algorithm uses an adaptive pooling size.

26. The processing unit system as recited in claim 25, wherein the KV management system is further capable of determining the adaptive pooling size using a sequence threshold parameter, grouping tokens in a key tensor into consecutive pages along a sequence dimension, storing a minimum key tensor and a maximum key tensor for each page, accumulating absolute values of each query in a group dimension, determining a set of largest indices along a head dimension, performing a sparse attention by fetching a KV vector using the set of largest indices, and retrieving corresponding KV pairs using the minimum key tensor when a sum of each query is less than zero or the maximum key tensor when the sum of each query is equal to or greater than zero.
